(19) United States
(12) Patent Application Publication
(10) Pub. No.: US 2008/0249828 A1
(43) Pub. Date: Oct. 9, 2008

(54) Method and System for Workscope Management and Control

(76) Inventors: James MacAuley, Lebanon, CT (US); Neil Fisk, Ellington, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/997,187

(22) PCT Filed: Mar. 29, 2006
(86) PCT No.: PCT/US06/11586

§ 371 Date: Jan. 29, 2008

(51) Int. Cl. G06Q 10/00; G06F 17/30

(52) U.S. Cl. 705/9

(57) ABSTRACT

A system, method or program for controlling a repair and maintenance process for equipment is provided. A database of source data based on original equipment manufacturer information is maintained, and a maintenance plan based at least in part on the source data is generated, which designates a workscope, and which can be electronically approved. A maintenance instruction based at least in part on the workscope is generated and a logical order is communicated within a maintenance center for inspection of the equipment based at least in part on the maintenance instruction. A repair instruction is communicated to a repair unit based at least in part on the inspection and a repair task is performed based at least in part on the repair instruction.

### BACKGROUND OF THE INVENTION

1. Field of the Invention

This disclosure relates generally to control and management of repair and maintenance, and more particularly, to a method and system for workscope management and control for a repair and maintenance process.

2. Description of the Related Art

Maintenance plans for commercial and industrial equipment include schedules and descriptions of specific tasks to be performed upon the equipment. For example, in an aircraft operator's off-wing maintenance plan, a workscope describes the maintenance schedule and procedure that needs to be performed on a gas turbine or other such engine during an engine shop visit. Contemporary workscopes are documentation signed by the customer and provided to the engine centers to guide inspectors in determining the tasks that must be accomplished. The contemporary workscope documentation can be several hundred pages long and is not tailored for a given shop visit.

The contemporary repair and maintenance process of FIG. 1 has a customized engine maintenance program (CEMP) or other such generated maintenance plan that is manually approved via emails, telephone conferences and faxes. Service begins in a service program through use of a shop maintenance instruction (SMI), or similar generated instruction. These are functionally equivalent and the term SMI will be used throughout. The SMI is communicated to the engine center for its use during the off-wing maintenance. The SMI instructions are transferred manually within the engine center system through a job order typically referred to as the logical order (LO) which provides high level instructions to the individual departments within the engine center. The (LO) references a MOD list which contains a list of service bulletins that are to be complied with during the shop visit to establish the desired engine configuration. This information, along with a copy of the CEMP is utilized for engine inspection at the engine center and results in an engine inspection record (EIR) being generated/modified. The inspector determines compliance with workscope requirements at this time.

Based upon the inspection at the engine center, a service master or technical instruction may need to be generated and communicated to the repair unit for performance of one or more repair tasks. Based upon this required repair as indicated in the service master, a sales order is generated. At this time, the repair unit is not utilizing, nor do they have access to, the CEMP. Once the repair is performed, an inspection occurs and, if satisfactory, then the customer requirements have been met for the contemporary repair and maintenance process.

The repaired/re-built engine is subjected to a manual audit by the quality assurance team at the engine center, which generates a summary or mini-pak of information as to maintenance and repair that was performed during this off-wing period. Typically, the customer then performs a high level audit as to the maintenance and repair that was performed during this same off-wing period.

The contemporary workscope documentation procedure and contemporary process described above, provides an open loop process. Repair units are not provided with the workscope documentation and do not have access to its information such as the level of maintenance that a module is receiving where the part is being installed or the parts intended time-on-wing requirements.

The contemporary process suffers from various drawbacks including the lack of access by the repair unit to the airline customer maintenance plan or CEMP. Part maintenance requirements are manually re-interpreted numerous times in the process often with less than optimum results. Technical deviation approvals take too long extending repair unit and engine center turnaround time. Late scrap and part condition feedback from repair units provides little opportunity to plan material logistics. Inspection/cleaning duplication at repair units and engine centers increases costs and there is no carry over of work accomplished. Engine center purchase orders to repair units are often unclear, vague, contain excessive legal data, and sometimes are incomplete. There is a limited ability to control actual workscope post-induction. There is also often conflicting statements in technical data which encourages workscope creep and repairs. When revisions to the CEMP are identified, updates to multiple customers are slow based on the current tedious document update, distribution and manual feedback process with each customer.

Accordingly, there is a need for a method and system to control and manage maintenance and repair for industrial and commercial equipment. There is a further need for a workscope control and management method and system that provides a closed loop process. There is yet a need for a workscope control and management method and system that develops or assists in the development and/or modification of workscopes, that allows for review and/or approval by multiple customers, that integrates Maintenance Center and Repair Unit processes, and/or that provides workscope feedback for process improvement.

### SUMMARY OF THE INVENTION

A method of controlling a repair and maintenance process for equipment is provided comprising: maintaining a database of source data based on original equipment manufacturer information; generating a maintenance plan based at least in part on the source data with the maintenance plan designating a workscope; generating a maintenance instruction based at least in part on the workscope; communicating the job requirements through a logical order to a maintenance center (e.g., internal departments thereof) for inspection of the equipment with the logical order being based at least in part on the maintenance instruction; communicating a repair instruction to a repair unit with the repair instruction being based at least in part on the inspection and/or the requirements of the maintenance plan; and performing a repair task based at least in part on the repair instruction.

In another aspect, a control system for a repair and maintenance process of equipment is provided. The system comprises a control processing unit in communication with a storage archive, a customer, a maintenance center and a repair unit. The control process unit has access to source data stored in the storage archive, wherein the source data is based on original equipment manufacturer information. The control processing unit generates a maintenance plan based at least in part on the source data, wherein the maintenance plan designates a workscope. The control processing unit generates a maintenance instruction based at least in part on the workscope. The control processing unit communicates a logical order within a maintenance center for inspection of the equipment, wherein the logical order is based at least in part on the maintenance instruction.

In yet another aspect, a computer readable program embodied in an article of manufacture comprising computer readable program instructions for controlling a repair and maintenance process for equipment is provided. The program comprises program instructions for causing a computer to maintain a database of source data based on original equipment manufacturer information; program instructions for causing the computer to generate a maintenance plan based at least in part on the source data with the maintenance plan designating a workscope; program instructions for causing the computer to generate a maintenance instruction based at least in part on the workscope; program instructions for causing the computer to communicate a logical order within the maintenance center for inspection of the equipment with the logical order being based at least in part on the maintenance instruction; and program instructions for causing the computer to communicate a repair instruction to a repair unit with the repair instruction being based at least in part on the inspection.

The method can further comprise inspecting the equipment based on the repair task performed; comparing the performed repair task with the workscope; and generating a workscope compliance report based on the comparison. This system generated audit may be more extensive than is currently possible. The workscope compliance report can also flag issues in real time to allow effective resolution. The method may further provide data and analysis that can be used to modify the maintenance plan based at least in part on the workscope compliance report. The original equipment manufacturer information can be generated at least in part from manuals, e.g., equipment manuals. The method may further comprise communicating changes in the workscope to the maintenance center and the repair unit. The method can further comprise removing redundant source data from the database.

The control processing unit may communicate a repair instruction to a repair unit. The control processing unit can generate a workscope compliance report based on a comparison of a performed repair task with the workscope. The control processing unit can provide analysis and reports that may be used to modify the maintenance plan based at least in part on the workscope compliance report. The control processing unit can communicate changes in the workscope to the maintenance center and the repair unit. The control processing unit may remove redundant source data from the storage archive.

The program may further comprise program instructions for causing the computer to generate a workscope compliance report based on a comparison of a performed repair task with the workscope. The program will provide analysis to identify opportunities to improve or optimize the maintenance plan based at least in part on the workscope compliance report. The combination of real-time automated analysis, plus the electronic customer approval process can dramatically improve the incorporation of these maintenance plan improvements. The analysis will also allow tailoring of the controls based on the level of workscope compliance at a specific part operation to insure maximum control is applied only where it is required to optimize the business process. The program may further comprise program instructions for causing the computer to generate the original equipment manufacturer information based at least in part on manuals. The program can further comprise program instructions for causing the computer to communicate changes in the workscope to the maintenance center and the repair unit. The program may further comprise program instructions for causing the computer to remove redundant source data from the database.

By managing and controlling the workscope of the repair and maintenance process, the present invention provides for systematic flow-down of customer requirements, with controls, accountability, and data visibility for continuous improvement.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a flow chart illustrating the contemporary repair and maintenance process that utilizes workscope documentation; and

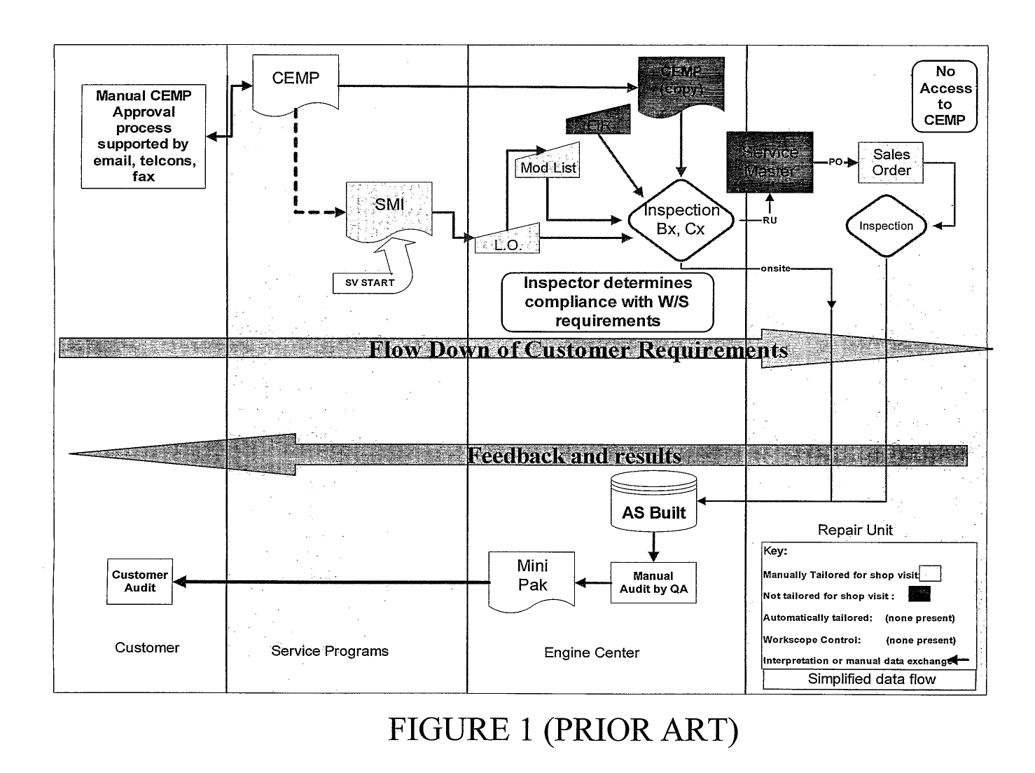

FIG. 2 is a flow chart illustrating the workscope control and management method and system of an exemplary embodiment of the present invention.

### DETAILED DESCRIPTION OF THE INVENTION

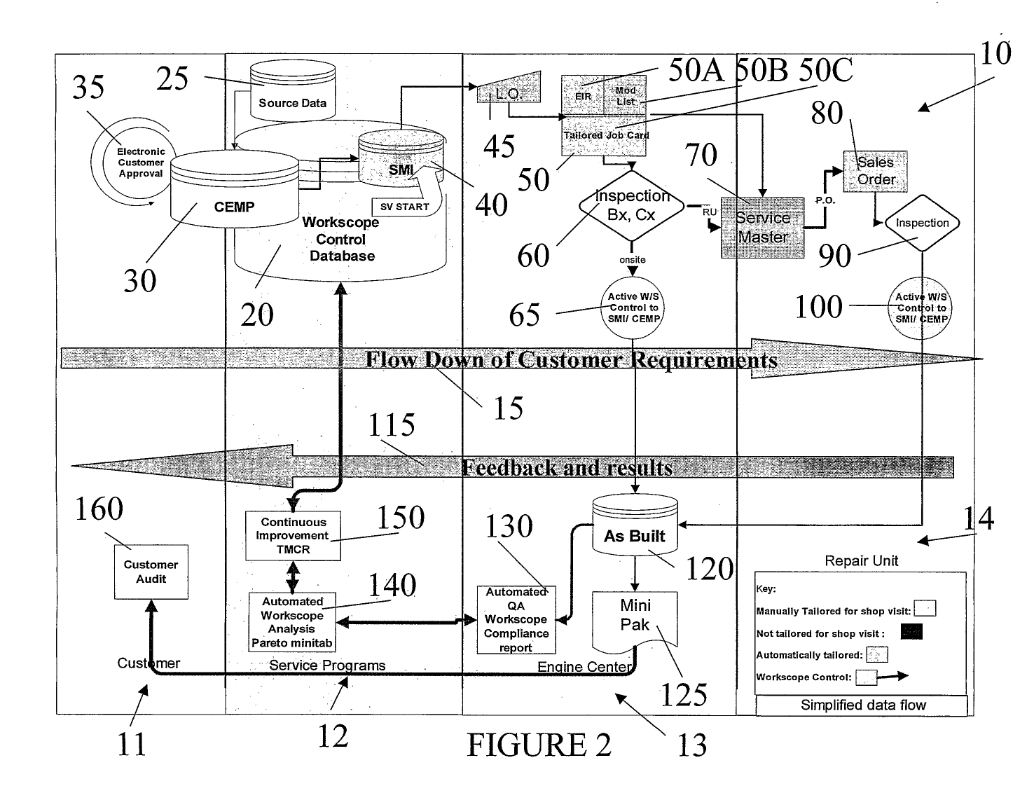

Referring to the drawings, and in particular to FIG. 2, a maintenance and repair system and/or process is shown and generally represented by reference numeral 10. While this System 10 may be used to maintain and repair any sort of equipment that requires routine or on-fault maintenance, it will be described in the context of maintaining and repairing a turbine engine, such as an aircraft engine. Those skilled in the art will recognize that the system 10 is equally applicable to maintenance and repair of other equipment such as aircraft, aircraft subsystems and/or parts, auxiliary power units, ground based turbine engines, maritime turbine engines, steam turbines, electric motors, electric generators, and any other equipment requiring routing or on-fault maintenance.

In the context of maintaining aircraft engines, system 10 includes, bit is not limited to, steps or procedures of the customer 11, the service program 12 (or other organization managing the customer maintenance planning), the maintenance center 13, such as an engine center, and the repair unit 14. The flow down and communication of customer requirements throughout the process is represented by arrow 15, while the feedback and communication of results throughout the process is represented by arrow 115. System 10 is described herein with respect to a repair and maintenance process for aircraft engines. However, the present disclosure contemplates the use of system 10 for various aircraft parts, as well as other types of commercial and industrial equipment.

The service program 12 or other similar organization generates and maintains the workscope control (WC) database 20. The WC database 20 can be implemented by various microprocessor and storage devices, such as, for example, a central processing unit (CPU). However, it is contemplated by the present disclosure for the WC database 20 to be implemented by any programmable circuit, such as, but not limited to, computers, processors, microcontrollers, microcomputers, programmable logic controllers, application specific integrated circuits, and other programmable circuits, as well as any number of such devices. It is further contemplated by the present disclosure that the CPU is any number of control devices providing various types of control, e.g., centralized, distributed, redundant and/or remote control. Additionally, communication between the WC database 20, customers 11, engine center 13, and repair unit 14 can be accomplished by various methods and structures including, but not limited to, network, internet and wireless communication.

WC database 20 stores or otherwise has access to source data 25 from original equipment manufacturer (OEM) engine manuals (or other such OEM equipment manuals). Typical source data from OEM manuals has overlapping content and is often presented in different formats and architecture. WC database 20 preferably can import this source data 25 and organize it into a non-redundant source of information stored in a storage archive that is readily and universally accessible.

Customers often require compliance to their native paperwork in native formats. WC database 20 preferably can generate reports and other communications in the native paperwork and native format that is required by the particular customer. WC database 20 can archive the source data into a consolidated source database that is accessible worldwide, and provide for meeting customer requirements for multiple customers.

Based at least in part upon the source data 25, a comprehensive engine maintenance program (CEMP) 30 is generated and/or modified. WC database 20 allows electronic customer approval of the newly generated/modified CEMP 30 to speed up the maintenance and repair process as in step 35. The system also facilitates line item customer approval, as opposed to contemporary cumbersome batch approval methods, to allow opportunities identified through the system analysis to be flowed to multiple customers and approved for timely implementation. The use of source data 25 allows for a CEMP 30 to be created which will result in specific shop visit requirements and customer specific requirements. CEMP 30 through the WC database 20 is readily available to the customer 11.

WC database 20 synthesizes the source data 25 into workscope specifications for the CEMP 30. Preferably, this is done through use of a standardized workscope specification format and platform, which will allow for standardization of workscopes across each of the various maintenance centers 13, such as engine centers. WC database 20 further provides for streamlined customer approval and regulatory approval by providing for timely communication of information. WC database 20 can modify multi-formatted workscope specifications.

The CEMP 30 is then utilized by WC database 20 for generating a shop maintenance instruction 40 for commencement of the service, such as off-wing service for an aircraft engine. The shop maintenance instruction 40 allows for communication of logical order 45 within the engine center 13, which provides the high level of instruction to the appropriate internal departments for maintenance to be performed on the engine. The logical order 45 in turn generates a single tailored instruction 50 that combines the requirements of the MOD list 50A, the engine inspection record 50B configuration requirements and a tailored job card 50C that is used for the inspection 60. The single tailored instruction 50 also can include the workscope, bill of material, modification (i.e. service bulletin) and engine manual instruction for the particular engine. Information gathered during the inspection 60 is used for active workscope control and refinement directly of the CEMP 30 and SMI 40, as shown in step 65. Tailored instruction 50 improves efficiency of the repair and maintenance process by eliminating redundant interpretations of the repair and maintenance requirements and customer requirements, and ensures all requirements are consistent at the detail level. This also reduces the research time required by the inspector.

If inspection 60 results in a repair task or the task is incorporated into the tailored instruction 50, then a service master 70 is communicated to the repair unit 14, which is a technical instruction for performance of one or more repair tasks. A sales order 80 is generated as a result of the repair task. During the repair process, the inspection 90 occurs at the repair unit. Similar to the feedback generated at the maintenance or engine center 13, the repair unit inspection 90 is used for active workscope control and analysis to identify improvements that can be made to the CEMP 30, as shown in step 100.

As the engine shop visit is completed in the engine center 13 as shown in step 120, a mini pak 125 is generated, which is a summary of repair and maintenance, for communication to the customer 11. Additionally, the engine center 13 generates an automated quality assurance workscope compliance report 130. An automated workscope analysis 140 can then be performed based at least in part on the workscope compliance report 130. The data obtained from the workscope analysis 140 is then stored by the WC database 20 as in step 150 and utilized for adjustment and refinement of the CEMP 30, and for generating an improved SMI 40 during any subsequent repair and maintenance period. Additionally, the customer audit 160 of the engine can occur while the automated quality assurance workscope compliance report 130 is being generated and while the workscope analysis 140 occurs.

System 10 is a flow down repair and maintenance process with a management and control mechanism that provides in-process, real-time results and feedback. The system 10 allows for analysis of the effect of workscope on cost. WC database 20 preferably performs statistical, trending and variance analysis on the data gathered during the off-wing repair and maintenance to improve cost and reduce off-wing time. System 10 is adjustable to allow for changes in the degree of control of specific repair tasks. Changes in the workscope are readily available to the engine center 12 and the repair unit 13 due to the communication established via WC database 20.

The process described herein (or portions of the process) is preferably one or more software programs or applications that can be run by a CPU, and is more preferably a computer program product having a computer useable medium with a computer readable code means embodied in the medium for control of the workscope of the repair and maintenance program. The software program or application is preferably readable by a CPU, tangibly embodying a program of instructions executable by the CPU to perform method steps for controlling and managing the maintenance and repair workscope. However, the present disclosure contemplates implementation of the method steps described herein, and the resulting control and managing of the workscope, in alternative ways as well.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

What is claimed is:

1. A method of controlling a repair and maintenance process for equipment comprising:
maintaining a database of source data based on original equipment manufacturer information;
generating a maintenance plan based at least in part on the source data, the maintenance plan designating a workscope;
generating a maintenance instruction based at least in part on the workscope;
communicating a logical order with a maintenance center for inspection of the equipment, the logical order being based at least in part on the maintenance instruction;
communicating a repair instruction to a repair unit, the repair instruction being based at least in part on the inspection; and
performing a repair task based at least in part on the repair instruction.

2. The method of claim 1, further comprising:
inspecting the equipment based on the repair task performed;
performing a comparison of the repair task performed with the workscope; and
generating a workscope compliance report based on the comparison.

3. The method of claim 2, further comprising:
modifying the maintenance plan based at least in part on the workscope compliance report.

4. The method of claim 3, further comprising:
electronically accepting customer approval of the maintenance plan.

5. The method of claim 1, wherein the original equipment manufacturer information is generated at least in part from equipment manuals.

6. The method of claim 1, further comprising:
communicating changes in the workscope to the maintenance center and the repair unit.

7. The method of claim 1, further comprising:
removing redundant source data from the database.

8. The method of claim 1, wherein the equipment is a turbine engine, aircraft sub-system or aircraft part.

9. A control system for a repair and maintenance process of equipment comprising:
a control processing unit in communication with a storage archive, a customer, a maintenance center and a repair unit, wherein the control process unit has access to source data stored in the storage archive, the source data being based on original equipment manufacturer information,
wherein the control processing unit generates a maintenance plan based at least in part on the source data, the maintenance plan designating a workscope,
wherein the control processing unit generates a maintenance instruction based at least in part on the workscope, and
wherein the control processing unit communicates a logical order to the maintenance center for inspection of the equipment, the logical order being based at least in part on the maintenance instruction.

10. The control system of claim 9, wherein the control processing unit communicates a repair instruction to a repair unit, the repair instruction being based at least in part on the inspection of the equipment.

11. The control system of claim 10, wherein the control processing unit generates a workscope compliance report based on a comparison of a performed repair task with the workscope.

12. The control system of claim 11, wherein the control processing unit modifies the maintenance plan based at least in part on the workscope compliance report.

13. The control system of claim 12, wherein the control processing unit reads a signal representative of customer approval of the maintenance plan.

14. The control system of claim 10, wherein the control processing unit communicates changes in the workscope to the maintenance center and the repair unit.

15. The control system of claim 9, wherein the control processing unit removes redundant source data from the storage archive.

16. The control system of claim 9, wherein the equipment is a turbine engine, aircraft sub-system or aircraft part.

17. A computer readable program embodied in an article of manufacture comprising computer readable program instructions for controlling a repair and maintenance process for equipment, said program comprising:
program instructions for causing a computer to maintain a database of source data based on original equipment manufacturer information;
program instructions for causing the computer to generate a maintenance plan based at least in part on the source data, the maintenance plan designating a workscope;
program instructions for causing the computer to generate a maintenance instruction based at least in part on the workscope;
program instructions for causing the computer to communicate a logical order with a maintenance center for inspection of the equipment, the logical order being based at least in part on the maintenance instruction; and
program instructions for causing the computer to communicate a repair instruction to a repair unit, the repair instruction being based at least in part on the inspection.

18. The program of claim 17, further comprising:
program instructions for causing the computer to generate a workscope compliance report based on a comparison of a performed repair task with the workscope.

19. The program of claim 18, further comprising:
program instructions for causing the computer to modify the maintenance plan based at least in part on the workscope compliance report.

20. The program of claim 19, further comprising:
program instructions for causing the computer to accept a signal representative of customer approval of the maintenance plan.

21. The program of claim 17, further comprising:
program instructions for causing the computer to generate the original equipment manufacturer information based at least in part on equipment manuals.

22. The program of claim 17, further comprising:
program instructions for causing the computer to communicate changes in the workscope to the maintenance center and the repair unit.

23. The program of claim 17, further comprising:
program instructions for causing the computer to remove redundant source data from the database.

24. The program of claim 17, wherein the equipment is a gas turbine engine, aircraft sub-system or aircraft part.

25. A system, method or program for controlling a repair and maintenance process for equipment as herein before described with reference to FIG. 2 of the accompanying drawings.
